(19) United States
(12) Patent Application Publication
(10) Pub. No.: US 2023/0280518 A1
(43) Pub. Date: Sep. 7, 2023

(54) DISPLAY DEVICE

(71) Applicant: Japan Display Inc., Tokyo (JP)

(72) Inventor: Tenfu NAKAMURA, Tokyo (JP)

(73) Assignee: Japan Display Inc., Tokyo (JP)

(21) Appl. No.: 18/179,368

(22) Filed: Mar. 7, 2023

(30) Foreign Application Priority Data
Mar. 7, 2022 (JP) 2022-034592

(51) Int. Cl. F21V 8/00; G02F 1/1334; G02F 1/1335

(52) U.S. Cl. CPC G02B 6/003; G02F 1/13347; G02F 1/133616; G02F 1/133331

(57) ABSTRACT

According to one embodiment, a display device includes a first substrate, a second substrate opposed to the first substrate, a polymer dispersed liquid crystal layer arranged between the first substrate and the second substrate, a first transparent substrate having a first side surface and opposed to the second substrate, and a first light source emitting light toward the first side surface. The second substrate has a second side surface on the first side surface side, the polymer dispersed liquid crystal layer is capable of switching a state in which light incident on the polymer dispersed liquid crystal layer is transmitted and a state in which the light is scattered, by applying a voltage.

### CROSS-REFERENCE TO RELATED APPLICATIONS

This application is based upon and claims the benefit of priority from Japanese Patent Application No. 2022-034592, filed Mar. 7, 2022, the entire contents of which are incorporated herein by reference.

### FIELD

Embodiments described herein relate generally to a display device.

### BACKGROUND

In recent years, a display device comprising a display panel including a polymer dispersed liquid crystal layer (PDLC) has been proposed. The polymer dispersed liquid crystal layer can switch a scattering state in which light is scattered and a transparent state in which light is transmitted. The display device can display images by switching the display panel to the scattering state. In contrast, the user can visually recognize a background through the display panel by switching the display panel to the transparent state.

In a display device comprising a polymer dispersed liquid crystal layer, for example, an edge-light system in which a light source is arranged at the edge of the light guide is often used. In the edge-light method, the luminance tends to decrease as the distance from the light source increases due to influences such as light leakage and light absorption.

### BRIEF DESCRIPTION OF THE DRAWINGS

FIG. 1 is a plan view showing a display device according to a first embodiment.

FIG. 2 is a cross-sectional view showing a configuration example of the display panel shown in FIG. 1.

FIG. 3 is an exploded perspective view showing the display device shown in FIG. 1.

FIG. 4 is a plan view showing an example of a low-refractive layer shown in FIG. 3.

FIG. 5 is a schematic cross-sectional view showing the display device taken along line V-V in FIG. 4.

FIG. 6 is a schematic cross-sectional view showing a comparative example of the display device according to the first embodiment.

FIG. 7 is a schematic cross-sectional view showing a display device according to a second embodiment.

FIG. 8 is an exploded perspective view showing a display device according to a third embodiment.

FIG. 9 is a schematic cross-sectional view showing the display device according to the third embodiment.

FIG. 10 is a schematic cross-sectional view showing a display device according to a fourth embodiment.

FIG. 11 is a plan view showing an example of a low-refractive layer shown in FIG. 10.

FIG. 12 is a schematic cross-sectional view showing a display device according to a fifth embodiment.

FIG. 13 is a schematic cross-sectional view showing a display device according to a sixth embodiment.

FIG. 14 is a schematic cross-sectional view showing a display device according to a seventh embodiment.

FIG. 15 is a schematic cross-sectional view showing a display device according to an eighth embodiment.

FIG. 16 is a schematic cross-sectional view showing a display device according to a ninth embodiment.

FIG. 17 is a schematic cross-sectional view showing a display device according to a tenth embodiment.

FIG. 18 is a schematic cross-sectional view showing a display device according to an eleventh embodiment.

FIG. 19 is a schematic cross-sectional view showing a display device according to a twelfth embodiment.

FIG. 20 is a schematic cross-sectional view showing a display device according to a thirteenth embodiment.

### DETAILED DESCRIPTION

In general, according to one embodiment, a display device comprises a first substrate, a second substrate opposed to the first substrate, a polymer dispersed liquid crystal layer arranged between the first substrate and the second substrate, a first transparent substrate having a first side surface and opposed to the second substrate, and a first light source emitting light toward the first side surface.

The second substrate has a second side surface on the first side surface side, the polymer dispersed liquid crystal layer is capable of switching a state in which light incident on the polymer dispersed liquid crystal layer is transmitted and a state in which the light is scattered, by applying a voltage, the light emitted from the first light source is made incident on the first transparent substrate from the first side surface to reach the polymer dispersed liquid crystal layer via the first transparent substrate and is not made incident from the second side surface.

According to another embodiment, a display device comprises a first substrate, a second substrate opposed to the first substrate, a polymer dispersed liquid crystal layer arranged between the first substrate and the second substrate, a transparent substrate having a side surface and opposed to the second substrate, a first light source emitting light toward the side surface, a first lens located between the side surface and the first light source, and a support member. The first substrate includes an extending portion which further extends than the side surface, the first lens overlaps with the extending portion in a thickness direction of the first substrate, the support member is located between the first lens and the extending portion.

According to the above-described configuration, a display device capable of suppressing the degradation in display quality can be provided.

Each of embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings are illustrated schematically rather than as an accurate representation of what is implemented, but such schematic illustration is merely exemplary, and in no way restricts the interpretation of the invention.

In the drawings, reference numbers of continuously arranged elements equivalent or similar to each other are omitted in some cases. In addition, in the specification and drawings, structural elements which function in the same or a similar manner to those described in connection with preceding drawings are denoted by like reference numbers, detailed description thereof being omitted unless necessary.

In each of the embodiments, the first direction X, second direction Y, and third direction Z are defined as shown in each figure. The first direction X, the second direction Y, and the third direction Z are orthogonal to each other, but may cross each other at an angle other than 90 degrees. In addition, the third direction Z is defined as an upper or upward direction while a direction opposite to the third direction Z is defined as a lower or downward direction, in each of the present embodiments.

Expressions such as “a second component above a first component” and “a second component beneath a first component” mean that the second component may be in contact with the first component or may be located apart from the first component. Viewing an X-Y plane defined by the first direction X and the second direction Y is hereinafter referred to as “viewing two-dimensionally”.

Each of the embodiments discloses a translucent liquid crystal display device having a visually recognizable background, to which polymer dispersed liquid crystal is applied. The embodiments do not prevent application of individual technical ideas disclosed in the embodiments to the other types of display devices.

### First Embodiment

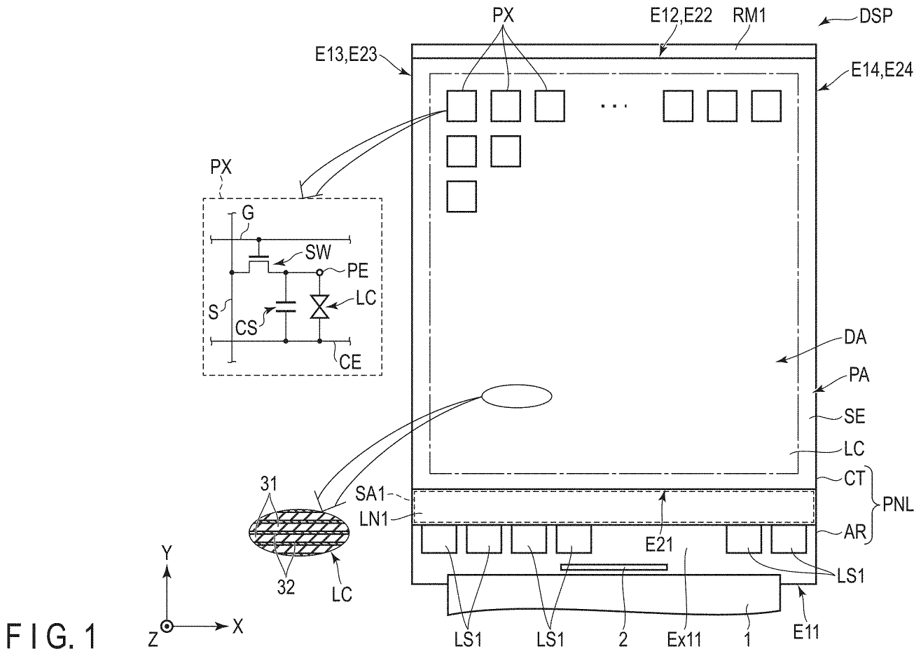

FIG. 1 is a plan view showing a display device DSP of the first embodiment. As shown in FIG. 1, the display device DSP comprises a display panel PNL including a polymer dispersed liquid crystal layer (hereinafter simply referred to as a liquid crystal layer LC), a wiring board 1, an IC chip 2, a lens LN1 (first lens), a light source LS1 (first light source), a reflective member RM1, and a support member SA1 (first support member). The display device DSP further comprises a transparent substrate 30 (first transparent substrate) to be described below, and a cover member 50.

The display panel PNL includes an array substrate AR, a counter-substrate CT opposed to the array substrate AR, a liquid crystal layer LC, and a seal SE. The array substrate AR and the counter-substrate CT have a flat shape parallel to an X-Y plane. The third direction Z corresponds to a thickness direction of the array substrate AR and the counter-substrate CT. The array substrate AR and the counter-substrate CT overlap as viewed two-dimensionally. The array substrate AR and the counter-substrate CT are bonded to each other with the seal SE. The liquid crystal layer LC is arranged between the array substrate AR and the counter-substrate CT and is sealed by the seal SE. In the first embodiment, the array substrate AR is an example of a first substrate and the counter-substrate CT is an example of a second substrate.

As enlarged and schematically shown in FIG. 1, the liquid crystal layer LC includes polymer 31 and liquid crystal molecules 32. The polymer 31 is, for example, liquid crystal polymer. The polymer 31 is formed in a stripe shape extending along the first direction X and is aligned in the second direction Y.

The liquid crystal molecules 32 are dispersed in gaps of the polymer 31 and aligned such that their long axes extend in the first direction X. The polymer 31 and the liquid crystal molecules 32 each have optical anisotropy or refractive anisotropy. The response performance of the polymer 31 to the electric field is lower than the response performance of the liquid crystal molecules 32 to the electric field.

As an example, the orientation of alignment of the polymer 31 is hardly changed irrespective of the presence or absence of the electric field. In contrast, the orientation of alignment of the liquid crystal molecules 32 is changed in accordance with the electric field in a state in which a voltage higher than or equal to a threshold value is applied to the liquid crystal layer LC.

For example, in a state in which the voltage is not applied to the liquid crystal layer LC, optical axes of the polymer 31 and the liquid crystal molecules 32 are parallel to each other, and the light made incident on the liquid crystal layer LC is not substantially scattered in the liquid crystal layer LC but is transmitted (transparent state). In a state in which the voltage is applied to the liquid crystal layer LC, the optical axes of the polymer 31 and the liquid crystal molecules 32 intersect each other and the light made incident on the liquid crystal layer LC is scattered in the liquid crystal layer LC (scattered state). The scattered state may be made in the state in which no voltage is applied to the liquid crystal layer LC, and the transparent state may be made in the state in which the voltage is applied to the liquid crystal layer LC.

The display panel PNL includes a display area DA on which images are displayed and a surrounding area PA located to surround the display area DA. The seal SE is located in the surrounding area PA. The display area DA includes pixels PX arrayed in a matrix in the first direction X and the second direction Y.

As enlarged and shown in FIG. 1, each pixel PX comprises a switching element SW, a pixel electrode PE, a common electrode CE, a liquid crystal layer LC, and the like. The switching element SW is constituted by, for example, a thin-film transistor (TFT) and is electrically connected to a scanning line G and a signal line S. The scanning line G is electrically connected to the switching element SW in each of the pixels PX arranged in the first direction X. The signal line S is electrically connected to the switching element SW in each of the pixels PX arranged in the second direction Y.

The pixel electrode PE is electrically connected to the switching element SW. The common electrode CE is provided commonly to a plurality of pixel electrodes PE. The liquid crystal layer LC (particularly, liquid crystal molecules 32) is driven by an electric field produced between the pixel electrode PE and the common electrode CE. A capacitor CS is formed, for example, between the common electrode CE and an electrode having the same potential and between the pixel electrode PE and an electrode having the same potential.

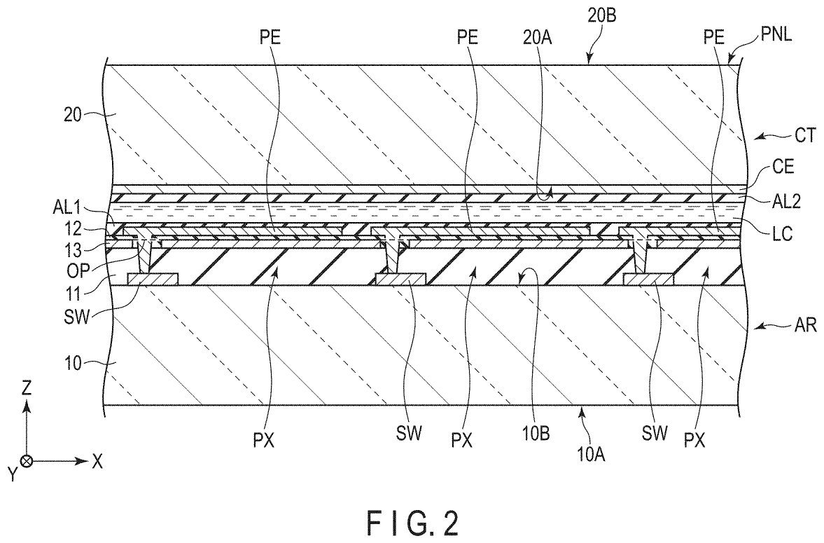

The scanning line G, the signal line S, the switching element SW, and the pixel electrode PE are provided on the array substrate AR, and the common electrode CE is provided on the counter-substrate CT, which will be described with reference to FIG. 2. On the array substrate AR, the scanning line G and the signal line S are electrically connected to the wiring board 1 or the IC chip 2.

The array substrate AR includes a pair of side surfaces E11 and E12 extending along the first direction X, and a pair of side surfaces E13 and E14 extending along the second direction Y. In the example shown in FIG. 1, the side surfaces E11 and E12 are the side surfaces formed along the short sides, and the side surfaces E13 and E14 are the side surfaces formed along the long sides.

The counter-substrate CT includes a pair of side surfaces E21 and E22 extending along the first direction X, and a pair of side surfaces E23 and E24 extending along the second direction Y. In the example shown in FIG. 1, the side surfaces E21 and E22 are the side surfaces formed along the short sides, and the side surfaces E23 and E24 are the side surfaces formed along the long sides.

In the example shown in FIG. 1, the side surfaces E12 and E22 overlap each other, the side surfaces E13 and E23 overlap each other, and the side surfaces E14 and E24 overlap each other, in planar view, but may not overlap.

The array substrate AR includes an extending portion Ex11 (first extending portion) which further extends than the side surface E21 of the counter-substrate CT. From another viewpoint, the extending portion Ex11 does not overlap with the counter-substrate CT. The side surface E11 is included in the extending portion Ex11. The side surface E21 is located between the side surface E11 and the display area DA in planar view. The shape of the array substrate AR and the counter-substrate CT is not limited to a rectangular shape.

The wiring board 1 and the IC chip 2 are mounted on the extending portion Ex11. The wiring board 1 is, for example, a flexible printed circuit board that can be bent and folded. The IC chip 2 incorporates, for example, a display driver which outputs a signal necessary for image display, and the like. The wiring board 1 and the IC chip 2 read signals from the display panel PNL in some cases, but mainly function as signal sources which supply signals to the display panel PNL. The IC chip 2 may be mounted on the wiring board 1.

In the example shown in FIG. 1, the display device DSP comprises a wiring board 1, but may comprise a plurality of wiring boards 1. The display device DSP comprises an IC chip 2, but may comprise a plurality of IC chips 2.

In the example shown in FIG. 1, the light source LS1, the lens LN1, and the support member SA1 overlap with the extending portion Ex11 in planar view. A plurality of light sources LS1 are arranged along the first direction X and spaced apart at intervals. The plurality of light sources LS1 are mounted on a wiring board F1 to be described below. The plurality of light sources LS1 are opposed to the lens LN1 in the second direction Y.

In the light source LS1, LEDs such as red LEDs, green LEDs, and blue LEDs are continuously arranged. The light source LS1 is not limited to the arrangement in which LEDs of three different colors are arranged continuously but, for example, only white light sources emitting white light may be continuously arranged.

The lens LN1 (for example, prism lens) is formed in a shape of a transparent rod and extends along the first direction X. The lens LN1 is formed of, for example, resin. The lens LN1 has, for example, a plurality of curved surfaces corresponding to the respective light sources LS1 and controls the width in the first direction X of the light emitted from the light sources LS1. The lens LN1 may be composed of a plurality of lenses. The number of light sources LS1 and the number of lenses LN1 are not limited to the example illustrated.

The reflective member RM1 is provided on a side opposite to the light sources LS1 in the second direction Y. In the example shown in FIG. 1, the reflective member RM1 extends along the side surfaces E12 and E22. The reflective member RM1 is formed of, for example, a metal material having an optical reflectance such as silver. As an example, the reflective member RM1 is a reflective tape.

FIG. 2 is a cross-sectional view showing a configuration example of the display panel PNL shown in FIG. 1. The array substrate AR includes a transparent substrate 10, insulating films 11 and 12, a capacitive electrode 13, switching elements SW, the pixel electrodes PE, and an alignment film AL1. The transparent substrate 10 includes a main surface 10A and a main surface 10B on a side opposite to the main surface 10A.

The switching elements SW are provided on the main surface 10B side. The insulating film 11 is provided on the main surface 10B and covers the switching elements SW. The scanning lines G and the signal lines S shown in FIG. 1 are provided between the transparent substrate 10 and the insulating film 11, but their illustration is omitted here. The capacitive electrode 13 is provided between the insulating films 11 and 12.

The pixel electrode PE is provided between the insulating film 12 and the alignment film AL1, in each pixel PX. In other words, the capacitive electrode 13 is provided between the transparent substrate 10 and the pixel electrodes PE. The pixel electrodes PE are electrically connected to the switching elements SW through apertures OP in the capacitive electrode 13. The pixel electrodes PE overlap with the capacitive electrode 13 with the insulating film 12 interposed therebetween, and form the capacitors CS of the pixels PX. The alignment film AL1 covers the pixel electrodes PE.

The counter-substrate CT is opposed to the array substrate AR. The counter-substrate CT includes a transparent substrate 20, a common electrode CE, and an alignment film AL2. The transparent substrate 20 includes a main surface 20A and a main surface 20B on a side opposite to the main surface 20A. The main surface 20A of the transparent substrate 20 is opposed to the main surface 10B of the transparent substrate 10.

The common electrode CE is provided on the main surface 20A. The alignment film AL2 covers the common electrode CE. The liquid crystal layer LC is located between the main surfaces 10B and 20A and is in contact with the alignment films AL1 and AL2. In the counter-substrate CT, a light-shielding layer may be provided just above each of the switching elements SW, the scanning lines G, and the signal lines S. In addition, a transparent insulating film may be provided between the transparent substrate 20 and the common electrode CE or between the common electrode CE and the alignment film AL2.

The common electrode CE is arranged over the plurality of pixels PX and is opposed to the plurality of pixel electrodes PE in the third direction Z. The common electrode CE has the same potential as the capacitive electrode 13. The liquid crystal layer LC is located between the pixel electrodes PE and the common electrode CE.

The transparent substrates 10 and 20 are, for example, glass substrates but may be insulating substrates such as plastic substrates. The insulating film 11 includes, for example, a transparent inorganic insulating film of silicon oxide, silicon nitride, silicon oxynitride or the like, and a transparent organic insulating film of acrylic resin or the like. The insulating film 12 is, for example, a transparent inorganic insulating film of silicon nitride or the like. The capacitive electrode 13, the pixel electrodes PE, and the common electrode CE are transparent electrodes formed of, for example, a transparent conductive material such as indium tin oxide (ITO) or indium zinc oxide (IZO).

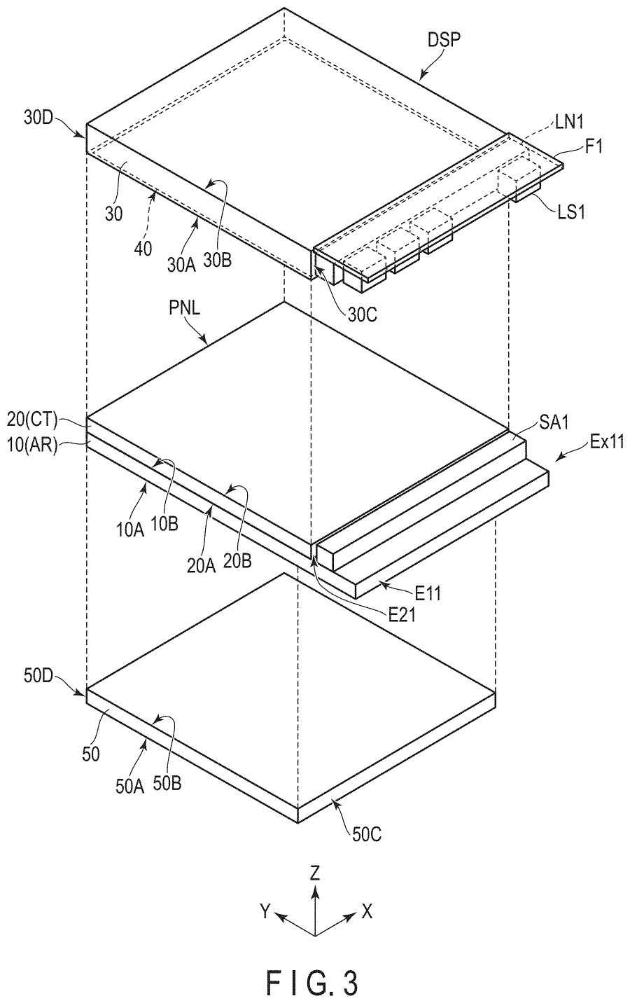

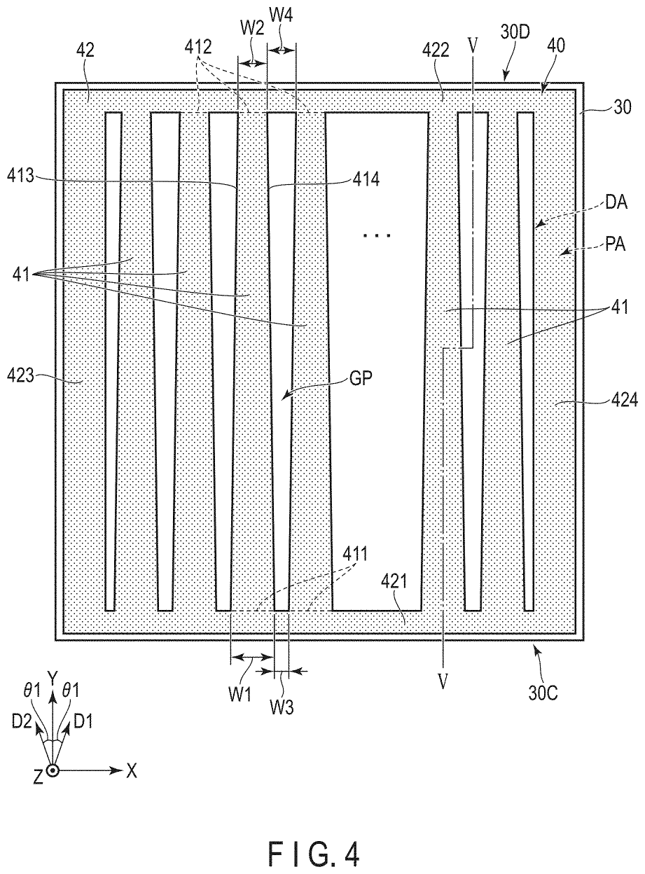

FIG. 3 is an exploded perspective view showing the display device DSP shown in FIG. 1. FIG. 4 is a plan view showing an example of a low-refractive layer 40 shown in FIG. 3. In FIG. 3 and FIG. 4, illustration of the reflective member RM1 and the like is partially omitted.

As described with reference to FIG. 1, the display device DSP comprises the display panel PNL, the lens LN1, the light source LS1, and the support member SA1. The display device DSP further comprises the transparent substrate 30, the low-refractive layer 40, the cover member 50, and the wiring board F1. The cover member 50, the array substrate AR, the counter-substrate CT, the low-refractive layer 40, and the transparent substrate 30 are arranged in this order along the third direction Z.

As described with reference to FIG. 1, the transparent substrate 10 has the side surface E11, in the array substrate AR. The transparent substrate 20 has the side surface E21, in the counter-substrate CT. The side surface E21 corresponds to a second side surface. The side surface E11 further protrudes than the side surface E21 of the transparent substrate 20 in a direction opposite to the second direction Y. The side surfaces E11 and E21 are the surfaces substantially parallel to an X-Z plane defined by the first direction X and the third direction Z.

The transparent substrate 30 has a flat plate shape parallel to the X-Y plane. The transparent substrate 30 has a main surface 30A, a main surface 30B on a side opposite to the main surface 30A, and a pair of side surfaces 30C and 30D that connect the main surface 30A with the main surface 30B. The side surface 30C corresponds to a first side surface. The main surfaces 30A and 30B are the surfaces substantially parallel to the X-Y plane. The main surface 30A is opposed to the main surface 20B of the transparent substrate 20.

A pair of side surfaces 30C and 30D are surfaces substantially parallel to the X-Z plane extending along the first direction X. The side surfaces E11 and E21 correspond to side surfaces located on the side surface 30C side in the second direction Y. The extending portion Ex11 further extends in a direction opposite to the second direction Y than the side surface 30C.

The cover member 50 has a flat plate shape parallel to the X-Y plane. The cover member 50 has a main surface 50A, a main surface 50B on a side opposite to the main surface 50A, and a pair of side surfaces 50C and 50D that connect the main surface 50A with the main surface 50B. The main surfaces 50A and 50B are the surfaces substantially parallel to the X-Y plane. The main surface 50B is opposed to the main surface 10A of the transparent substrate 10.

A pair of side surfaces 50C and 50D are surfaces substantially parallel to the X-Z plane extending along the first direction X. The transparent substrate 30 and the cover member 50 do not overlap with the extending portion Ex11 in the third direction Z.

The plurality of light sources LS1 are mounted on the wiring board F1. The wiring board F1 is, for example, a printed circuit board and has more rigidity than the wiring board 1 shown in FIG. 1. The plurality of light sources LS1 and the lens LN1 are opposed to the side surface 30C in the second direction Y. The plurality of light sources LS1 emit light toward the side surface 30C. The lens LN1 is located between the side surface 30C and the light sources LS1 in the second direction Y. The support member SA1 is located between the extending portion Ex11 and the lens LN1 in the third direction Z.

The support member SA1 is a rod-shaped member extending along the first direction X. The support member SA1 is formed of, for example, acrylic resin, glass, or the like, but the material is not limited to this example. The support member SA1 is desirably formed of an opaque and untransparent material. When the support member SA1 is formed of a transparent material, for example, the surface of the support member SA1 may be processed to be untransparent. The support member SA1 may be a single member or may be composed of a plurality of members.

The low-refractive layer 40 is arranged on the main surface 30A of the transparent substrate 30, which is located on the liquid crystal layer LC side. The low-refractive layer 40 has a refractive index n2 lower than a refractive index n1 of the transparent substrate 30 (n1>n2). In the example shown in FIG. 4, the low-refractive layer 40 includes a plurality of strip portions 41 and a frame portion 42 surrounding the plurality of strip portions 41.

The plurality of strip portions 41 are arranged at intervals in the first direction X. Each of the strip portions 41 extends along the second direction Y. The low-refractive layer 40 does not overlap with the main surface 30A at a position between the adjacent strip portions 41. For example, the strip portions 41 and the frame portion 42 are formed integrally.

The strip portion 41 includes a first end portion 411 on the side surface 30C side, a second end portion 412 on a side opposite to the first end portion 411, a first edge 413, and a second edge 414. The first end portion 411 and the second end portion 412 have a first width W1 and a second width W2 in the first direction X, respectively. In the example shown in FIG. 4, the first width W1 is greater than the second width W2.

The first edge 413 and the second edge 414 extend in a direction different from the first direction X and the second direction Y, at positions between the first end portion 411 and the second end portion 412. For example, a direction intersecting the second direction Y counterclockwise at an acute angle is defined as direction D1, and a direction intersecting the second direction Y clockwise at an acute angle is defined as direction D2.

An angle θ1 formed between the second direction Y and the direction D1 is, for example, the same as the angle θ1 formed between the second direction Y and the direction D2, but the angles are not limited to this example and the angle formed between the second direction Y and the direction D1 may be different from the angle formed between the second direction Y and the direction D2.

The first edge 413 extends along the direction D1, and the second edge 414 extends along the direction D2. Each of the first edge 413 and the second edge 414 extends linearly, but may be formed in a curved shape. The first width W1 and the second width W2 correspond to intervals between the first edge 413 and the second edge 414. The strip portion 41 in this shape has the width decreasing at a constant rate or any rate, from the first end portion 411 toward the second end portion 412, along the second direction Y.

When two strip portions 41 are focused, a gap between the first end portions 411 has a third width W3 in the first direction X, and a gap between the second end portions 412 has a fourth width W4 in the first direction X. At the gap GP between the adjacent strip portions 41, the width increases at a constant rate or any rate, from the third width W3 toward the fourth width W4, along the second direction Y.

Although described later, an area overlapping with the strip portions 41 corresponds to an area where the light incident on the transparent substrate 30 is not made substantially incident on the display panel PNL side. In contrast, an area overlapping with the gap G between the adjacent strip portions 41 corresponds to an area where the light incident on the transparent substrate 30 can be made incident on the display panel PNL side.

When the low-refractive layer 40 overlaps with the display panel PNL, the plurality of strip portions 41 overlap with the display area DA, and the frame portion 42 overlaps with the surrounding area PA, in planar view. For example, an outer shape of the frame portion 42 is located inside an outer shape of the transparent substrate 30. An area inside the frame portion 42 corresponds to the display area DA.

The frame portion 42 includes a first portion 421 and a second portion 422 which extend along the first direction X, and a third portion 423 and a fourth portion 424 which extend along the second direction Y. The first portion 421 is located between the side surface 30C and the display area DA, and the second portion 422 is located between the side surface 30D and the display area DA, in the second direction Y.

In the example shown in FIG. 4, the first portion 421 is connected to the first end portion 411 of each of the strip portions 41, and the second portion 422 is connected to the second end portion 412 of each of the strip portions 41. The strip portion 41 does not include edges parallel to the first direction X, in the display area DA, and the first edge 413 and the second edge 414 inclined to the first direction X and the second direction Y overlap with the display area DA.

The transparent substrate 30 is formed of, for example, glass or an organic material such as polymethyl methacrylate (PMMA) or polycarbonate (PC). The low-refractive layer 40 is a transparent organic film and is formed of, for example, an organic material such as siloxane-based resin or fluorine-based resin. The low-refractive layer 40 may be a transparent inorganic film. The refractive index n1 of the transparent substrate 30 is approximately 1.5, and the refractive index n2 of the low-refractive layer 40 is approximately 1.0 to 1.4. The cover member 50 is an insulating substrate such as a glass substrate or plastic substrate.

The shape of the strip portions 41 is not limited to the example shown in FIG. 4, but may be the other shape. The amount of the light made incident on the display panel PNL side can be adjusted by changing the shape of the strip portions 41 and changing the size of the strip portions 41.

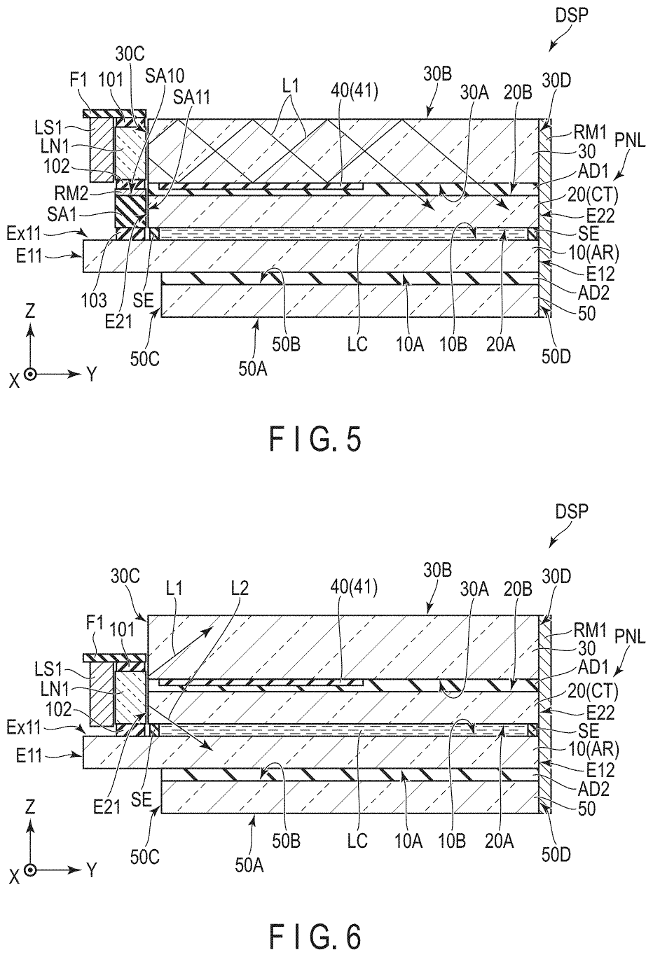

FIG. 5 is a schematic cross-sectional view showing the display device DSP taken along line V-V in FIG. 4. In FIG. 5, illustration of the wiring board 1, the IC chip 2, and the like is partially omitted. The only main parts of the display panel PNL is illustrated simply.

As described with reference to FIG. 3, the transparent substrate 30 has the main surface 30A, the main surface 30B, and the pair of side surfaces 30C and 30D. In the example shown in FIG. 5, the side surface 30C is located just above the side surface E21 in the third direction Z, and the side surface 30D is located just above the side surface E22.

As described with reference to FIG. 3, the cover member 50 has the main surface 50A, the main surface 50B, and the pair of side surfaces 50C and 50D. In the example shown in FIG. 5, the side surface 50C is further separated from the light source LS1 than the side surface 30C in the second direction Y. The side surface 50C is not located just under the side surface 30C in the third direction Z, but may be located just under the side surface 30C.

In contrast, the side surface 50D is located just under the side surface 30D in the third direction Z. The side surface 50D, the side surface E12, the side surface E22, and the side surface 30D are aligned along the third direction Z, but may be displaced. The side surface E12, the side surface E22, the side surface 30D, and the side surface 50D are located on a side opposite to the side surface 30C in the second direction Y.

The display device DSP further comprises an adhesive layer AD1 and an adhesive layer AD2. In the example shown in FIG. 5, the adhesive layer AD1 bonds the main surface 20B of the transparent substrate 20 to the main surface 30A of the transparent substrate 30. The low-refractive layer 40 including the strip portions 41 is in contact with the main surface 30A. The adhesive layer AD1 is in contact with a substantially entire surface of the main surface 20B, covers the low-refractive layer 40, and is in contact with the main surface 30A in an area where the low-refractive layer 40 is lost.

In the example shown in FIG. 5, the adhesive layer AD2 bonds the main surface 10A of the transparent substrate 10 to the main surface 50B of the cover member 50. The adhesive layer AD2 is in contact with the main surface 10A and is in contact with a substantially entire surface of the main surface 50B. The adhesive layers AD1 and AD2 are transparent and formed of, for example, optical clear adhesive (OCA) or the like. The adhesive layers AD1 and AD2 may be formed of optical clear resin (OCR).

In the example shown in FIG. 5, each of the transparent substrate 10, the transparent substrate 20, and the cover member 50 has a substantially equal thickness in the third direction Z. The thickness in the third direction Z of the transparent substrate 30 is greater than the thickness in the third direction Z of each of the transparent substrate 10, the transparent substrate 20, and the cover member 50. The thickness in the third direction Z of the transparent substrate 30 may be equal to the thickness in the third direction Z of each of the transparent substrate 10, the transparent substrate 20, and the cover member 50. As an example, the thickness in the third direction Z of the transparent substrate 30 is greater than the thickness in the third direction Z of the lens LN1.

The refractive index of each of the transparent substrates 10 and 20, the adhesive layers AD1 and AD2, and the cover member 50 is equal to the refractive index n1 of the transparent substrate 30 and is higher than the refractive index n2 of the low-refractive layer 40. In this case, “equal” implies not only a case where the refractive index difference is zero, but also a case where the refractive index difference is 0.03 or less. The refractive index of the adhesive layers AD1 and AD2 is, for example, 1.474.

The wiring board F1, the light source LS1, and the lens LN1 overlap with the extending portion Ex11 in the third direction Z. From another viewpoint, the light source LS1 and the lens LN1 are provided between the extending portion Ex11 and the wiring board F1 in the third direction Z. The support member SA1 is provided between the extending portion Ex11 and the lens LN1.

In the example shown in FIG. 5, the support member SA1 has a rectangular cross-section. The support member SA1 has a main surface SA10 and a side surface SA11. The main surface SA10 is opposed to the lens LN1. The side surface SA11 is opposed to the side surface E21 of the transparent substrate 20. The support member SA1 includes a reflective member RM2 provided on the main surface SA10. The reflective member RM2 is, for example, a sheet capable of reflecting light such as enhanced specular reflector (ESR). The light from the lens LN1 hardly reaches the side surface E21 via the support member SA1 by providing the reflective member RM2 on the main surface SA10. The reflective member RM2 may also be provided on a surface other than the main surface 30A.

For convenience of descriptions, in the example shown in FIG. 1, the size of the support member SA1 is smaller than the size of the lens LN1 in planar view, but the size of the support member SA1 is, desirably, substantially the same as the size of the lens LN1 in planar view. The width in the second direction Y of the lens LN1 is substantially equal to the width in the second direction Y of the support member SA1. As an example, the width in the third direction Z of the support member SA1 is substantially equal to the thickness in the third direction Z of the transparent substrate 20. The width in the third direction Z of the support member SA1 may be greater than the thickness in the third direction Z of the transparent substrate 20.

The main surface SA10 and the main surface 20B are located in the same plane along the X-Y plane. From another viewpoint, the distance from the main surface 10B of the transparent substrate 10 to the main surface SA10 is substantially equal to the distance from the main surface 10B to the main surface 20B.

The lens LN1 is bonded to the wiring board F1 by an adhesive layer 101, and is bonded to the support member SA1 by an adhesive layer 102. The support member SA1 is bonded to the main surface 10B at the extending portion Ex11 by an adhesive layer 103. The adhesive layers 101, 102 and 103 are, for example, adhesive members such as double-sided tapes.

The light source LS1, the lens LN1, and the transparent substrate 30 are arranged in this order along the second direction Y. The light source LS1 and the lens LN1 are opposed to the side surface 30C. The lens LN1 is located above the support member SA1, and the light source LS1 and the lens LN1 are not opposed to the side surface E21. The reflective member RM1 is provided entirely from the side surface 30D to the side surface 50D along the third direction Z.

Next, the light emitted from the light sources LS1 will be described. The light emitted from the light sources LS1 is diffused moderately at the lens LN1, and is made incident on the transparent substrate 30 from the side surface 30C. In contrast, the light sources LS1 and the lens LN1 are not opposed to the side surface E21 of the transparent substrate 20 as described above. For this reason, the light emitted from the light sources LS1 is not made incident from the side surface E21. In this case, “not incident” implies not only a case where no light is made incident, but also a case where light is made slightly incident.

Furthermore, since the reflective member RM2 is provided on the main surface SA10 of the support member SA1, incidence of the light from the side surface E21 is further suppressed. The light made incident on the transparent substrate 30 from the side surface 30C reaches the liquid crystal layer LC through the transparent substrate 30.

As described above, the refractive index n2 of the low-refractive layer 40 is lower than the refractive index n1 of the transparent substrate 30. For this reason, light traveling from the transparent substrate 30 toward the low-refractive layer 40, of the light L1 made incident on the transparent substrate 30, is reflected on an interface between the transparent substrate 30 and the low-refractive layer 40. The light traveling toward the main surface 30B, of the light L1 made incident on the transparent substrate 30, is reflected on an interface between the transparent substrate 30 and an air layer. The light L1 travels inside the transparent substrate 30 while being repeatedly reflected, in the vicinity of the side surface 30C (or the area where the low-refractive layer 40 is provided).

Light traveling toward the area where the low-refractive layer 40 is not provided, i.e., the area where the transparent substrate 30 is in contact with the adhesive layer AD1, of the light L1, is transmitted through the transparent substrate 30, and is transmitted through the transparent substrate 20 via the adhesive layer AD1. The incidence of the light L1 from the light sources LS1 on the display panel PNL is suppressed in the area close to the light sources LS1. In contrast, the incidence of the light L1 on the display panel PNL is promoted in the area remote from the light sources LS1.

All the light L1 is not made incident on the display panel PNL in the area close to the light sources LS1, but the light L1 is made incident on the display panel PNL from the gap GP between the adjacent strip portions 41 as shown in FIG. 4.

Since the side surface 30D is covered with the reflective member RM1, the light L1 reaching the side surface 30D is scattered and reflected by the reflective member RM1 to travel inside the transparent substrate 30 in a direction opposite to the second direction Y. It is possible to suppress the light L1 leaking out of the side surface 30D by providing the reflective member RM1 and to improve the light use efficiency by reusing the light.

The light made incident on the liquid crystal layer LC to which no voltage is applied is transmitted through the liquid crystal layer LC while being hardly scattered. In contrast, the light made incident on the liquid crystal layer LC to which the voltage is applied is scattered in the liquid crystal layer LC. The display device DSP allows images to be observed from the main surface 30B side and also allows images to be observed from the main surface 50A side.

The display device DSP is so-called a transparent display and, even when the display device DSP is observed from the main surface 30B side or the main surface 50A side, a background of the display device DSP can be observed via the display device DSP.

FIG. 6 is a schematic cross-sectional view showing a comparative example of the display device DSP according to the first embodiment. In the example shown in FIG. 6, the display device DSP does not comprise the support member SA1, and the lens LN1 is bonded to the extending portion Ex11 by the adhesive layer 102. The light source LS1 and the lens LN1 are opposed to each of the side surface 30C and the side surface E21. The light emitted from the light source LS1 is made incident on each of the transparent substrate 20 and the transparent substrate 30 via the lens LN1.

In the comparative example shown in FIG. 6, light L2 incident on the transparent substrate 20 is made incident directly on the liquid crystal layer LC from the transparent substrate 20. The light incident on the liquid crystal layer LC reduces due to influences such as light leakage, light absorption and the like as the light is remote from the light source LS1. For this reason, the luminance becomes higher in the area close to the light source LS1, the luminance becomes lower in the area remote from the light source LS1, and the luminance in the area close to the light source LS1 and the area remote from the light source LS1 can hardly become uniform. In the display device DSP in the example shown in FIG. 6, the light L2 incident on the transparent substrate 20 is more likely to increase than the light L1 incident on the transparent substrate 30 from the light source LS1.

According to the embodiment, the light emitted from the light sources LS1 is not made incident from the side surface E21, but incident on the transparent substrate 30 via the side surface 30C. By making the light incident on the transparent substrate 30, the light outcoupling efficiency can be controlled by the transparent substrate 30 which functions as a light guide.

As shown in FIG. 4, the width in the first direction X of the gap GP between the adjacent strip portions 41 increases along the second direction Y, and the incidence of the light on the display panel PNL side is more promoted in the area remote from the light sources LS1 than in the area close to the light sources LS1. From another viewpoint, the area where the incidence of the light on the display panel PNL side is promoted is larger in the area remote from the light sources LS1 than in the area close to the light sources LS1.

Thus, the light incident on the liquid crystal layer LC is controlled by making the light from the side surface 30C of the transparent substrate 30 incident, and the influences such as light leakage, light absorption and the like can be suppressed as compared with a case where the light is also made incident from the side surface E12. Furthermore, since the reflective member RM1 is provided on the side opposite to the light sources LS1 in the second direction Y, the luminance of the area remote from the light sources LS1 can be improved on the display panel PNL.

Therefore, the luminance difference in the area close to the light source LS1 and the area remote from the light source LS1 can be reduced, and the degradation in display quality can be suppressed by making the luminance on the display panel PNL uniform.

As described above, according to the embodiment, the display device DSP capable of suppressing the degradation in display quality can be provided.

### Second Embodiment

A second embodiment will be described. The same constituent elements as those of the first embodiment are denoted by the same reference symbols, and their description is omitted as appropriate.

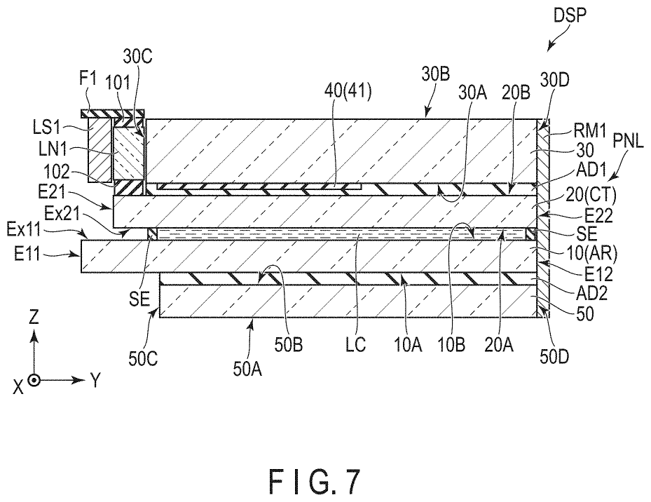

FIG. 7 is a schematic cross-sectional view showing a display device DSP according to a second embodiment. In the second embodiment, an array substrate AR is an example of a first substrate, and a counter-substrate CT is an example of a second substrate. A configuration of the display panel PNL is the same as that of the above-described first embodiment. The display device DSP of the second embodiment is different from that of the first embodiment in that a transparent substrate 20 includes an extending portion Ex21, on the counter-substrate CT, instead of a support member SA1. The extending portion Ex21 of the transparent substrate 20 on the counter-substrate CT corresponds to a second extending portion.

The transparent substrate 20 includes the extending portion Ex21. The extending portion Ex21 further extends in a direction opposite to the second direction Y than a side surface 30C. In the example shown in FIG. 7, an extending portion Ex11 further extends in a direction opposite to the second direction Y than the extending portion Ex21. A transparent substrate 30 does not overlap with the extending portion Ex11 or Ex21 in the third direction Z.

A lens LN1 overlaps with the extending portion Ex21 in the third direction Z. From another viewpoint, the lens LN1 is provided between the extending portion Ex21 and the wiring board F1 in the third direction Z. The extending portion Ex21 may extend up to a position overlapping with the light source LS1 in the third direction Z.

The lens LN1 is bonded to a wiring board F1 by an adhesive layer 101, and bonded to a main surface 20B on the extending portion Ex21 by an adhesive layer 102. The light source LS1, the lens LN1, and the transparent substrate 30 are arranged in this order along the second direction Y. The light source LS1 and the lens LN1 are opposed to the side surface 30C. The lens LN1 is located above the extending portion Ex21, and the light source LS1 and the lens LN1 are not opposed to a side surface E21.

The same advantages as those of the first embodiment can also be obtained from the configuration of the present embodiment.

### Third Embodiment

A third embodiment will be described. The same constituent elements as those of each of the above-described embodiments are denoted by the same reference symbols, and their description is omitted as appropriate.

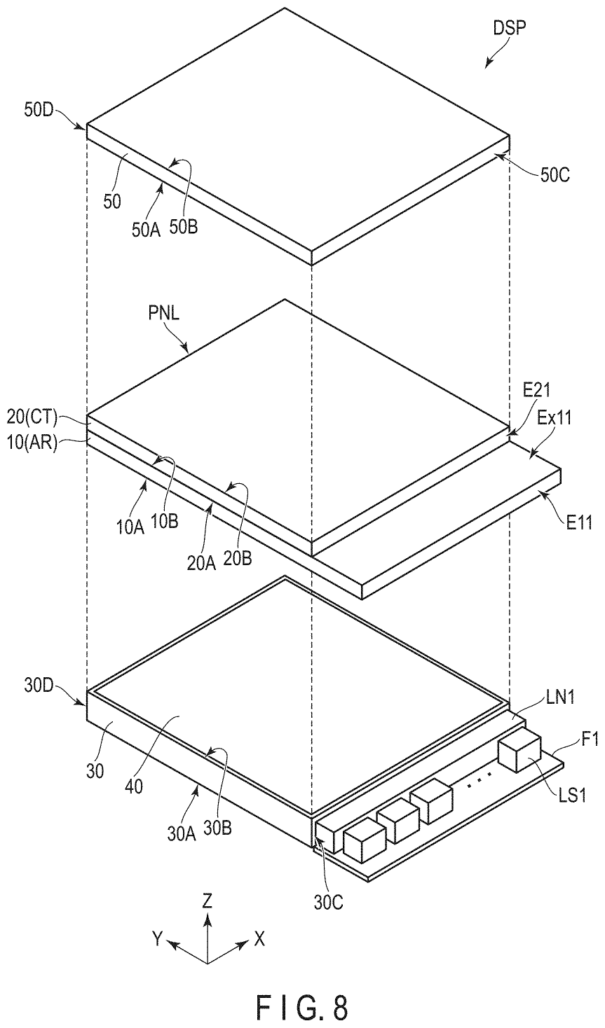

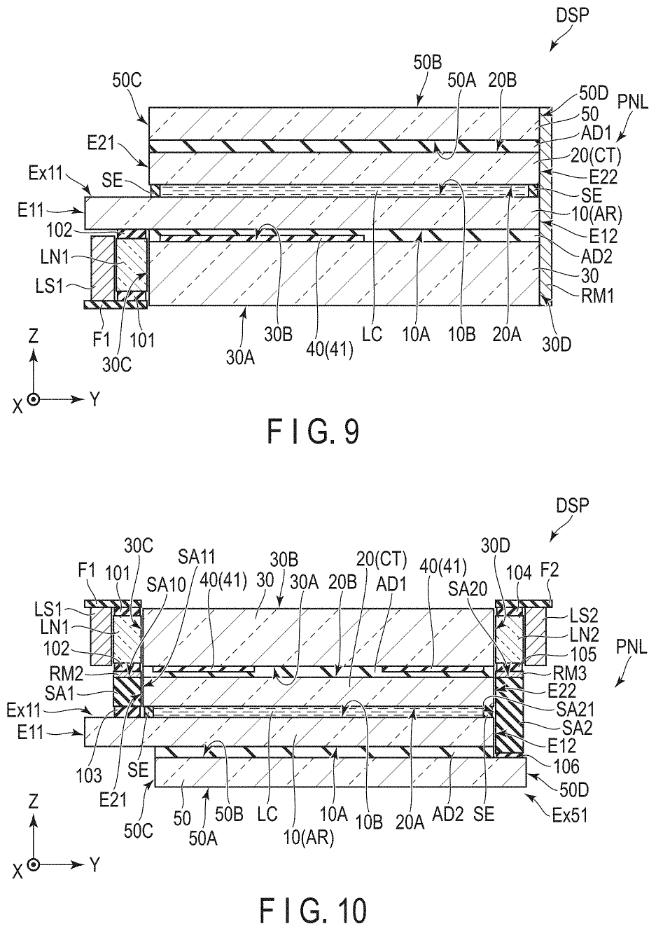

FIG. 8 is an exploded perspective view showing a display device DSP of the third embodiment. FIG. 9 is a schematic cross-sectional view showing the display device DSP of the third embodiment. In the third embodiment, the array substrate AR is an example of a second substrate, and the counter-substrate CT is an example of a first substrate. An extending portion Ex11 of a transparent substrate 10 on the counter-substrate CT corresponds to a third extending portion.

A configuration of the display panel PNL is the same as that of each of the above-described embodiments. The display device DSP of the third embodiment is different from that of each of the above-described embodiments in that a light source LS1, a lens LN1, and the like are located under a display panel PNL.

In the display device DSP of the third embodiment, a transparent substrate 30, a low-refractive layer 40, the array substrate AR, the counter-substrate CT and a cover member 50 are arranged in this order along the third direction Z. A main surface 30B of the transparent substrate 30 is opposed to a main surface 10A of a transparent substrate 10. A main surface 50A of the cover member 50 is opposed to a main surface 20B of a transparent substrate 20.

In the example shown in FIG. 9, a side surface 30C is located just under a side surface E21 in the third direction Z, and a side surface 30D is located just under a side surface E22. A side surface 50C is located just above the side surface E21 in the third direction Z, and a side surface 50D is located just above the side surface E22. The side surface 50C, the side surface E21, the side surface 30C are aligned along the third direction Z, but may be displaced.

A low-refractive layer 40 includes a plurality of strip portions 41 arranged at intervals in the first direction X, and a frame portion 42 surrounding the strip portions 41 as shown in FIG. 4. The low-refractive layer 40 including the strip portions 41 is arranged on the main surface 30B of the transparent substrate 30, which is located on the liquid crystal layer LC side.

In the third embodiment, an adhesive layer AD1 bonds a main surface 20B of a transparent substrate 20 to the main surface 50A of the cover member 50. An adhesive layer AD2 bonds a main surface 10A of a transparent substrate 10 to the main surface 30B of the wiring substrate 30. The adhesive layer AD2 is in contact with the main surface 10A, covers the low-refractive layer 40, and is in contact with the main surface 30B in an area where the low-refractive layer 40 is lost.

The light source LS1 and the lens LN1 overlap with the extending portion Ex11 in the third direction Z. The lens LN1 is bonded to the wiring board F1 by an adhesive layer 101 and is bonded to the main surface 10A on the extending portion Ex11 by an adhesive layer 102. The light source LS1, the lens LN1, and the transparent substrate 30 are arranged in this order along the second direction Y. The light source LS1 and the lens LN1 are opposed to the side surface 30C. The lens LN1 is located under the extending portion Ex11, and the light source LS1 and the lens LN1 are not opposed to the side surface E11 or E21. For this reason, the light emitted from the light source LS1 is not made incident from the side surface E11 or E21.

Next, the light emitted from the light sources LS1 will be described. The light emitted from the light sources LS1 is diffused moderately at the lens LN1, and is made incident on the transparent substrate 30 from the side surface 30C. Light traveling from the transparent substrate 30 toward the low-refractive layer 40, of the light made incident on the transparent substrate 30, is reflected on an interface between the transparent substrate 30 and the low-refractive layer 40.

The light traveling toward the main surface 30A, of the light made incident on the transparent substrate 30, is reflected on an interface between the transparent substrate 30 and an air layer. The light in the vicinity of the side surface 30C travels inside the transparent substrate 30 while being repeatedly reflected.

Light traveling toward the area where the low-refractive layer 40 is not provided, i.e., the area where the transparent substrate 30 is in contact with the adhesive layer AD2, of the light emitted from the light sources LS1, is transmitted through the transparent substrate 30, and is transmitted through the transparent substrate 10 via the adhesive layer AD2.

The same advantages as those of each of the above-described embodiments can also be obtained from the configuration of the present embodiment.

### Fourth Embodiment

A fourth embodiment will be described. The same constituent elements as those of each of the above-described embodiments are denoted by the same reference symbols, and their description is omitted as appropriate.

FIG. 10 is a schematic cross-sectional view showing a display device DSP according to the fourth embodiment. In the fourth embodiment, an array substrate AR is an example of a first substrate, and a counter-substrate CT is an example of a second substrate. A side surface 30D of a transparent substrate 30 corresponds to a third side surface. A side surface E22 of a transparent substrate 20 on the counter-substrate CT corresponds to a fourth side surface, and a side surface E12 of a transparent substrate 10 on the array substrate AR corresponds to a fifth side surface.

A configuration of the display panel PNL is the same as that of each of the above-described embodiments. The display device DSP of the fourth embodiment further comprises a light source LS2 (second light source), a lens LN2 (second lens), a wiring board F2, and a support member SA2 (second support member). A cover member 50 further includes an extending portion Ex51.

The extending portion Ex51 further extends along the second direction Y than the side surface 30D. From another viewpoint, the extending portion Ex51 extends toward a side opposite to an extending portion Ex11. The extending portion Ex51 includes a side surface 50D. The side surface 50D further protrudes than the side surface 30D in the second direction Y. The transparent substrate 30 does not overlap with the extending portion Ex11 or Ex51 in the third direction Z.

A plurality of light sources LS2 are mounted on a wiring board F2. The wiring board F2 is, for example, a printed circuit board and has more rigidity than the wiring board 1 shown in FIG. 1. The plurality of light sources LS2 are arranged at intervals along the first direction X, similarly to the light sources LS1 (first light sources). The plurality of light sources LS2 are opposed to the lens LN2 in the second direction Y.

In the light sources LS2, red LEDs, green LEDs, and blue LEDs are continuously arranged. The light source LS2 is not limited to those in the arrangement in which LEDs of three different colors are arranged continuously but may be, for example, only white light sources emitting white light, which are continuously arranged.

The lens LN2 (for example, prism lens) is formed in a shape of a transparent rod and extends along the first direction X, similarly to the lens LN1 (first lens). The lens LN2 is formed of, for example, resin. The lens 2 has, for example, a plurality of curved surfaces corresponding to the respective light sources LS2 and controls the width in the first direction X of the light emitted from the light sources LS2. The lens LN2 may be composed of a plurality of lenses.

The light sources LS2 emit light toward the side surface 30D of the transparent substrate 30 from a side opposite to the light sources LS1, in the second direction Y. The plurality of light sources LS2 are opposed to the side surface 30D in the second direction Y.

The lens LN2 is located between the side surface 30D and the light sources LS2 in the second direction Y. The wiring board F2 and the lens LN2 overlap with the extending portion Ex51 in the third direction Z. From another viewpoint, the lens LN2 is provided between the extending portion Ex51 and the wiring board F2 in the third direction Z. The extending portion Ex51 may extend up to a position overlapping with the light sources LS2 in the third direction Z.

A support member SA2 is provided between the extending portion Ex51 and the lens LN2. The support member SA2 is a rod-shaped member extending along the first direction X, similarly to the support member SA1 (first support member). The support member SA2 is formed of, for example, acrylic resin, glass, or the like, but the material is not limited to this example. The support member SA2 is desirably formed of an opaque and untransparent material. The support member SA2 may be a single member or may be composed of a plurality of members.

In the example shown in FIG. 10, the support member SA2 has a rectangular cross-section. The support member SA2 has a main surface SA20 and a side surface SA21. The main surface SA20 is opposed to the lens LN2. The side surface SA21 is opposed to the side surface E12 of the transparent substrate 10 and the side surface E22 of the transparent substrate 20. The support member SA2 includes a reflective member RM3 provided on the main surface SA20. The reflective member RM3 is, for example, a reflective member similar to the reflective member RM2.

The size of the support member SA2 is, desirably, substantially equal to the size of the lens LN2 in planar view. The width in the second direction Y of the lens LN2 is substantially equal to the width in the second direction Y of the support member SA2. As an example, the width in the third direction Z of the support member SA2 is greater than the thickness in the third direction Z of the transparent substrates 10 and 20. In the example shown in FIG. 10, the main surfaces SA10, SA20, and 20B are located in the same plane along the X-Y plane.

The lens LN2 is bonded to the wiring board F2 by an adhesive layer 104, and is bonded to the support member SA2 by an adhesive layer 105. The support member SA2 is bonded to a main surface 50B at the extending portion Ex51 by an adhesive layer 106. The adhesive layers 104, 105, and 106 are, for example, double-sided tapes or the like.

The light source LS2, the lens LN2, and the transparent substrate 30 are arranged in this order along a direction opposite to the second direction Y. The light source LS2 and the lens LN2 are opposed to the side surface 30D. The lens LN2 is located above the support member SA2, and the light source LS2 and the lens LN2 are not opposed to the side surface E12 or E22.

The light source LS2 emits light toward the side surface 30D. The light emitted from the light source LS2 is diffused moderately on the lens LN2, and is made incident on the transparent substrate 30 from the side surface 30D. In contrast, the lens LN2 is not opposed to the side surface E12 or E22 as described above. For this reason, the light emitted from the light source LS2 is not made incident from the side surface E12 or E22. The light made incident on the transparent substrate 30 from the side surface 30D reaches the liquid crystal layer LC through the transparent substrate 30. The light incident on the transparent substrate 30 travels inside the display panel PNL while being repeatedly reflected.

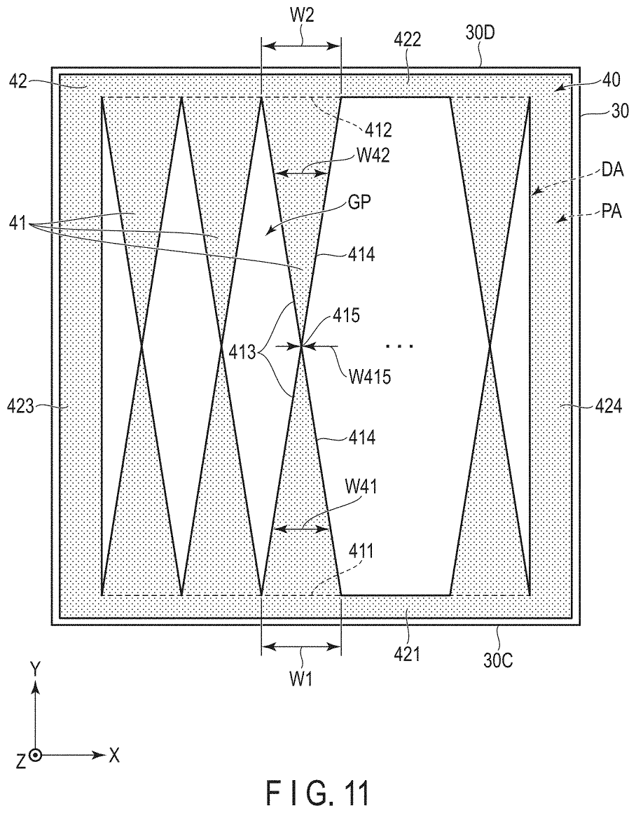

FIG. 11 is a plan view showing an example of the low-refractive layer 40 shown in FIG. 10. The low-refractive layer 40 in FIG. 11 is different from the low-refractive layer 40 shown in FIG. 4 in that a width W41 of strip portions 41 decreases at a central portion 415 between a first end portion 411 and a second end portion 412.

A first width W1 of the first end portion 411 is greater than a width W415 of the central portion 415, and a second width W2 of the second end portion 412 is larger than the width W415 of the central portion 415. The width W41 of the strip portions 41 decreases from the first end portion 411 to the central portion 415. A width W42 of the strip portions 41 decreases from the second end portion 412 to the central portion 415.

When two adjacent strip portions 41 are focused, a width in the first direction X increases from the first end portion 411 side (side surface 30C side) toward a central portion, and the width in the first direction X decreases from the central portion toward the second end portion 412 side (side surface 30D side), along the second direction Y, at the gap GP between the adjacent strip portions 41. As shown in FIG. 10, a low-refractive layer 40 including the strip portions 41 is located in an area close to the light source LS1 and an area close to the light source LS2.

The light source LS1 and the light source LS2 are arranged at a position opposed to the side surface 30C and a position opposed to the side surface 30D, respectively. From another viewpoint, a first portion 421 is located between the light source LS1 and the display area DA, and a second portion 422 is located between the light source LS2 and the display area DA. A luminance difference on the display panel PNL can be further reduced by emitting light toward the side surfaces 30C and 30D of the transparent substrate 30.

Furthermore, a more amount of the light incident from the side surfaces 30C and 30D of the transparent substrate 30 can be made to reach the center of the display panel by decreasing the widths W41 and W42 of the strip portion 41 at the central portion 415, in the low-refractive layer 40.

For this reason, degradation in luminance at the central portion of the display panel PNL can be suppressed, and the degradation in display quality can be suppressed by making the luminance uniform on the display panel PNL. The same advantages as those of each of the above-described embodiments can also be obtained from the configuration of the present embodiment.

### Fifth Embodiment

A fifth embodiment will be described. The same constituent elements as those of each of the above-described embodiments are denoted by the same reference symbols, and their description is omitted as appropriate.

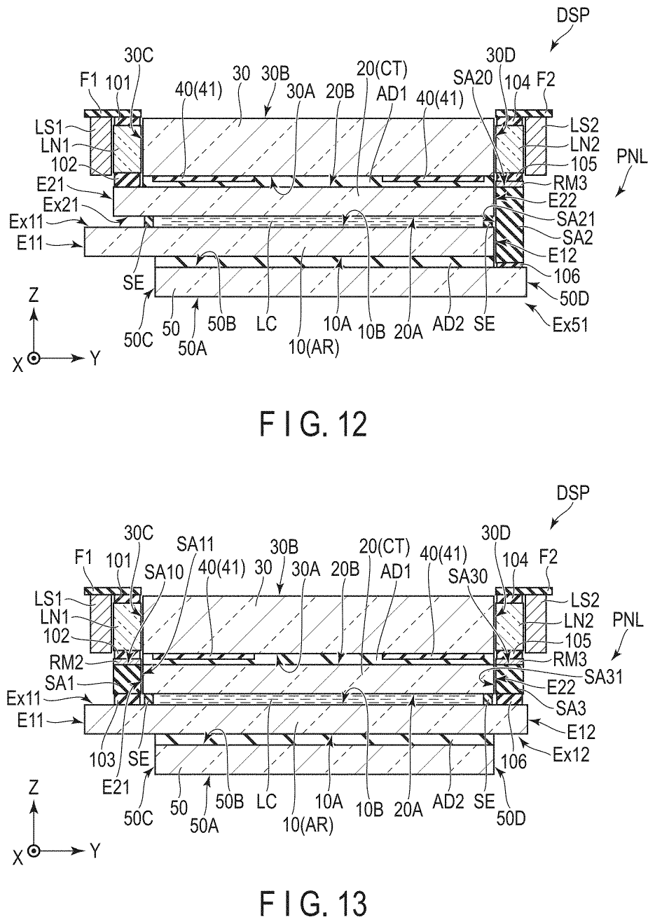

FIG. 12 is a schematic cross-sectional view showing a display device DSP according to the fifth embodiment. In the fifth embodiment, an array substrate AR is an example of a first substrate, and a counter-substrate CT is an example of a second substrate. A configuration of the display panel PNL is the same as that of each of the above-described embodiments. The display device DSP of the fifth embodiment is different from that of the fourth embodiment in that a transparent substrate 20 includes an extending portion Ex21 (second extending portion), on the counter-substrate CT, instead of a support member SA1. The extending portion Ex21 has been described above.

The same advantages as those of each of the above-described embodiments can also be obtained from the configuration of the present embodiment.

### Sixth Embodiment

A sixth embodiment will be described. The same constituent elements as those of each of the above-described embodiments are denoted by the same reference symbols, and their description is omitted as appropriate.

FIG. 13 is a schematic cross-sectional view showing a display device DSP according to the sixth embodiment. In the sixth embodiment, an array substrate AR is an example of a first substrate, and a counter-substrate CT is an example of a second substrate. A configuration of the display panel PNL is the same as that of each of the above-described embodiments. The display device DSP of the sixth embodiment is different from that of the fourth embodiment in that the display device comprises a support member SA3 (third support member) instead of a support member SA2 and that a transparent substrate 10 includes an extending portion Ex12 on the array substrate AR. An extending portion Ex12 of a transparent substrate 10 on the array substrate AR corresponds to a fourth extending portion.

The extending portion Ex12 further extends in the second direction Y than a side surface 30D. From another viewpoint, the extending portion Ex12 extends toward a side opposite to an extending portion Ex11. The side surface E12 is included in the extending portion Ex12. The side surface E12 further protrudes than the side surface 30D in the second direction Y. A transparent substrate 30 does not overlap with the extending portion Ex11 or Ex12 in the third direction Z.

A wiring board F2 and a lens LN2 overlap with the extending portion Ex12 in the third direction Z. From another viewpoint, the lens LN2 is provided between the extending portion Ex12 and the wiring board F2 in the third direction Z. The extending portion Ex12 may extend up to a position overlapping with the light source LS2 in the third direction Z.

A support member SA3 is provided between the extending portion Ex12 and the lens LN2. The support member SA3 is a rod-shaped member extending along the first direction X, similarly to a support member SA1. The support member SA3 is formed of, for example, a resin material such as acrylic resin or glass, but the material is not limited to this example. The support member SA3 is desirably formed of an opaque and untransparent material. The support member SA3 may be a single member or may be composed of a plurality of members. For example, the support member SA3 is the same member as the support member SA1.

In the example shown in FIG. 13, the support member SA3 has a rectangular cross-section. The support member SA3 has a main surface SA30 and a side surface SA31. The main surface SA30 is opposed to the lens LN2. The side surface SA31 is opposed to a side surface E22 of a transparent substrate 20. The support member SA3 includes a reflective member RM3 provided on the main surface SA30.

The size of the support member SA3 is, desirably, substantially equal to the size of the lens LN2 in planar view. The width in the second direction Y of the lens LN2 is substantially equal to the width in the second direction Y of the support member SA3. As an example, the width in the third direction Z of the support member SA3 is substantially equal to the thickness in the third direction Z of the transparent substrate 20. The width in the third direction Z of the support member SA3 may be greater than the thickness in the third direction Z of the transparent substrate 20. In the example shown in FIG. 13, the main surfaces SA10, SA30, and 20B are located in the same plane along the X-Y plane.

The lens LN2 is bonded to the wiring board F2 by an adhesive layer 104, and is bonded to the support member SA3 by an adhesive layer 105. The support member SA3 is bonded to the main surface 10B at the extending portion Ex12 by an adhesive layer 106.

The light source LS2, the lens LN2, and the transparent substrate 30 are arranged in this order along a direction opposite to the second direction Y. The light source LS2 and the lens LN2 are opposed to the side surface 30D. The lens LN2 is located above the support member SA3, and the light source LS2 and the lens LN2 are not opposed to the side surface E12 or E22. For this reason, the light emitted from the light sources LS2 is not made incident from the side surface E22.

The same advantages as those of each of the above-described embodiments can also be obtained from the configuration of the present embodiment.

### Seventh Embodiment

A seventh embodiment will be described. The same constituent elements as those of each of the above-described embodiments are denoted by the same reference symbols, and their description is omitted as appropriate.

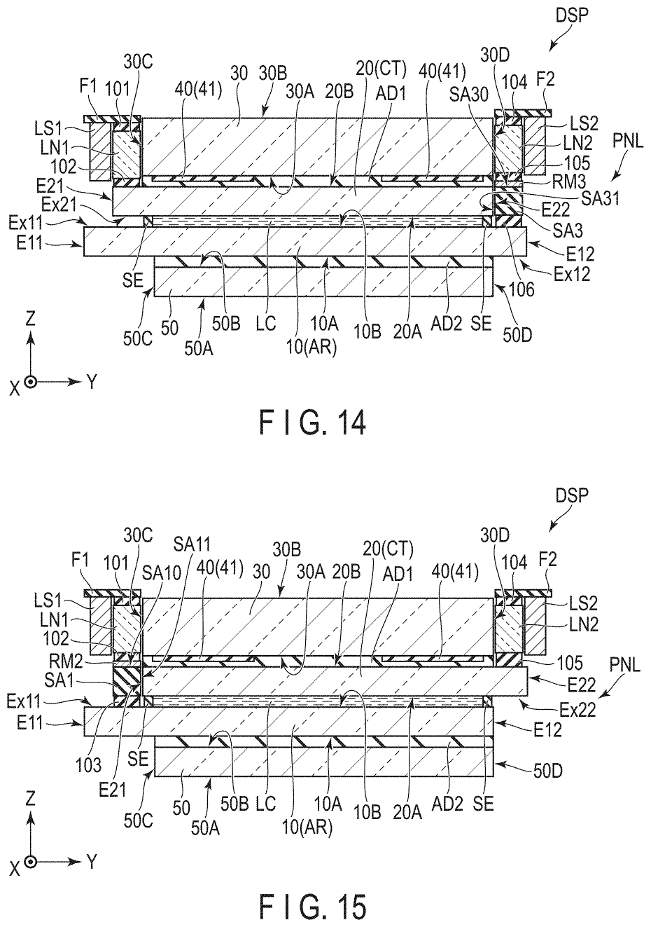

FIG. 14 is a schematic cross-sectional view showing a display device DSP according to the seventh embodiment. In the seventh embodiment, an array substrate AR is an example of a first substrate, and a counter-substrate CT is an example of a second substrate. A configuration of the display panel PNL is the same as that of each of the above-described embodiments. The display device DSP of the seventh embodiment is different from that of the sixth embodiment in that a transparent substrate 20 includes an extending portion Ex21 (second extending portion), on the counter-substrate CT, instead of a support member SA1. The extending portion Ex21 has been described above.

The same advantages as those of each of the above-described embodiments can also be obtained from the configuration of the present embodiment.

### Eighth Embodiment

An eighth embodiment will be described. The same constituent elements as those of each of the above-described embodiments are denoted by the same reference symbols, and their description is omitted as appropriate.

FIG. 15 is a schematic cross-sectional view showing a display device DSP according to the eighth embodiment. In the eighth embodiment, an array substrate AR is an example of a first substrate, and a counter-substrate CT is an example of a second substrate. A configuration of the display panel PNL is the same as that of each of the above-described embodiments. The display device DSP of the eighth embodiment is different from that of the fourth embodiment in that a transparent substrate 20 includes an extending portion Ex22, on the counter-substrate CT, instead of a support member SA2. The extending portion Ex22 of the transparent substrate 20 on the counter-substrate CT corresponds to a fifth extending portion.

The transparent substrate 20 includes the extending portion Ex22. The extending portion Ex22 further extends along the second direction Y than a side surface 30D. From another viewpoint, the extending portion Ex22 extends toward a side opposite to an extending portion Ex11. A side surface E22 is included in the extending portion Ex22. The side surface E22 further protrudes than the side surface 30D in the second direction Y. A transparent substrate 30 does not overlap with the extending portion Ex11 or Ex22 in the third direction Z.

A wiring board F2 and a lens LN2 overlap with the extending portion Ex22 in the third direction Z. From another viewpoint, the lens LN2 is provided between the extending portion Ex22 and the wiring board F2 in the third direction Z. The extending portion Ex22 may extend up to a position overlapping with the light source LS2 in the third direction Z. The lens LN2 is bonded to a wiring board F2 by an adhesive layer 104, and bonded to a main surface 20B on the extending portion Ex22 by an adhesive layer 105.

The light source LS2, the lens LN2, and the transparent substrate 30 are arranged in this order along a direction opposite to the second direction Y. The light source LS2 and the lens LN2 are opposed to the side surface 30D. The lens LN2 is located above the extending portion Ex22, and the light source LS2 and the lens LN2 are not opposed to the side surface E12 or E22. For this reason, the light emitted from the light sources LS2 is not made incident from the side surface E22.

The same advantages as those of each of the above-described embodiments can also be obtained from the configuration of the present embodiment.

### Ninth Embodiment

A ninth embodiment will be described. The same constituent elements as those of each of the above-described embodiments are denoted by the same reference symbols, and their description is omitted as appropriate.

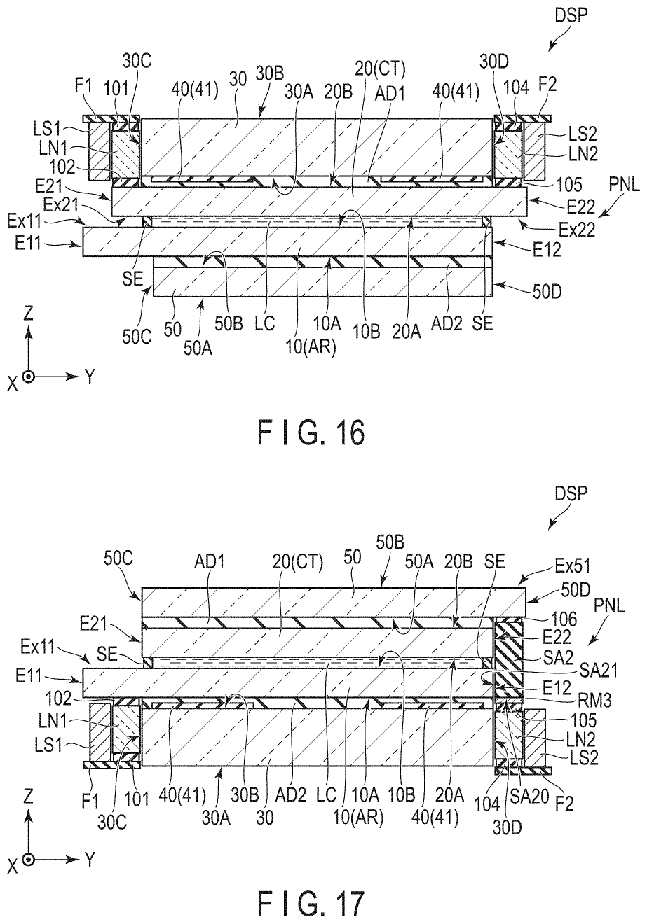

FIG. 16 is a schematic cross-sectional view showing a display device DSP according to the ninth embodiment. In the ninth embodiment, an array substrate AR is an example of a first substrate, and a counter-substrate CT is an example of a second substrate. A configuration of the display panel PNL is the same as that of each of the above-described embodiments. The display device DSP of the ninth embodiment is different from that of the eighth embodiment in that a transparent substrate 20 includes an extending portion Ex21 (second extending portion), on the counter-substrate CT, instead of a support member SA1. The extending portion Ex21 has been described above.

The same advantages as those of each of the above-described embodiments can also be obtained from the configuration of the present embodiment.

### Tenth Embodiment

A tenth embodiment will be described. The same constituent elements as those of each of the above-described embodiments are denoted by the same reference symbols, and their description is omitted as appropriate.

FIG. 17 is a schematic cross-sectional view showing a display device DSP according to the tenth embodiment. In the tenth embodiment, the array substrate AR is an example of a second substrate, and the counter-substrate CT is an example of a first substrate. A side surface 30D of a transparent substrate 30 corresponds to a third side surface. A side surface E12 of a transparent substrate 10 on the array substrate AR corresponds to a fourth side surface, and a side surface E22 of a transparent substrate 20 on the counter-substrate CT corresponds to a fifth side surface. An extending portion Ex11 of a transparent substrate 10 on the array substrate AR corresponds to a third extending portion.

A configuration of the display panel PNL is the same as that of each of the above-described embodiments. The display device DSP of the tenth embodiment is different from that of each of the fourth to ninth embodiments in that light sources LS1 and LS2, lenses LN1 and LN2, and the like are located under the display panel PNL.

In the display device DSP of the tenth embodiment, a transparent substrate 30, a low-refractive layer 40, the array substrate AR, the counter-substrate CT and a cover member 50 are arranged in this order along the third direction Z. A main surface 30B of the transparent substrate 30 is opposed to a main surface 10A of a transparent substrate 10. A main surface 50A of the cover member 50 is opposed to a main surface 20B of a transparent substrate 20.

A side surface 30C is opposed to a plurality of light sources LS1 in the second direction Y. A side surface 30D is opposed to a plurality of light sources LS2 in the second direction Y. In the example shown in FIG. 17, a side surface 30C is located just under a side surface E21 in the third direction Z, and a side surface 30D is located just under a side surface E22. A side surface 50C is located just above the side surface E21 in the third direction Z.

On the array substrate AR, the transparent substrate 10 includes an extending portion Ex11. The cover member 50 includes an extending portion Ex51. The transparent substrate 30 does not overlap with the extending portion Ex11 or Ex51 in the third direction Z.

A low-refractive layer 40 includes a plurality of strip portions 41 arranged at intervals in the first direction X, and a frame portion 42 surrounding the strip portions 41 as shown in FIG. 11. The low-refractive layer 40 including the strip portions 41 is arranged on the main surface 30B of the transparent substrate 30, which is located on the liquid crystal layer LC side.

In the tenth embodiment, an adhesive layer AD1 bonds a main surface 20B of a transparent substrate 20 to the main surface 50A of the cover member 50. An adhesive layer AD2 bonds a main surface 10A of a transparent substrate 10 to the main surface 30B of the wiring substrate 30. The adhesive layer AD2 is in contact with the main surface 10A, covers the low-refractive layer 40, and is in contact with the main surface 30B in an area where the low-refractive layer 40 is lost.

The lens LN2 overlaps the extending portion Ex51 in the third direction Z. From another viewpoint, the lens LN2 is provided between the extending portion Ex51 and the wiring board F2 in the third direction Z.

A support member SA2 is provided between the extending portion Ex51 and the lens LN2. The support member SA2 has a main surface SA20 and a side surface SA21. The main surface SA20 is opposed to the lens LN2. The side surface SA21 is opposed to the side surface E12 of the transparent substrate 10 and the side surface E22 of the transparent substrate 20. The support member SA2 includes a reflective member RM3 provided on the main surface SA20. In the example shown in FIG. 17, the main surfaces SA20 and 10A are located in the same plane along the X-Y plane.

The lens LN2 is bonded to the wiring board F2 by an adhesive layer 104, and is bonded to the support member SA2 by an adhesive layer 105. The support member SA2 is bonded to the main surface 50A at the extending portion Ex51 by an adhesive layer 106.

The light source LS2, the lens LN2, and the transparent substrate 30 are arranged in this order along a direction opposite to the second direction Y. The light source LS2 and the lens LN2 are opposed to the side surface 30D. The lens LN2 is located under the support member SA2, and the light source LS2 and the lens LN2 are not opposed to the side surface E12 or E22. For this reason, the light emitted from the light source LS2 is not made incident from the side surface E12 or E22.

The same advantages as those of each of the above-described embodiments can also be obtained from the configuration of the present embodiment.

### Eleventh Embodiment

An eleventh embodiment will be described. The same constituent elements as those of each of the above-described embodiments are denoted by the same reference symbols, and their description is omitted as appropriate.

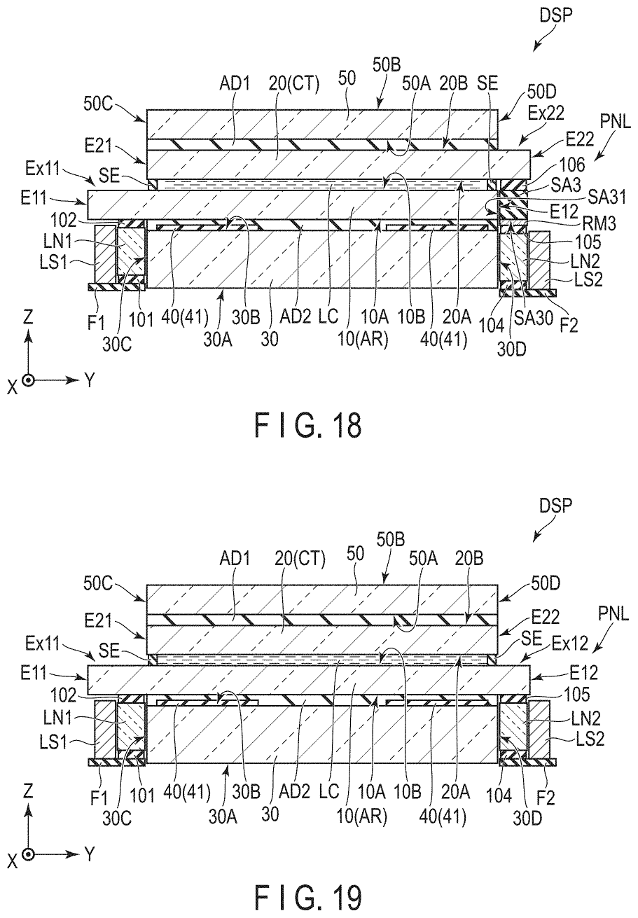

FIG. 18 is a schematic cross-sectional view showing a display device DSP according to the eleventh embodiment. In the eleventh embodiment, the array substrate AR is an example of a second substrate, and the counter-substrate CT is an example of a first substrate. A configuration of the display panel PNL is the same as that of each of the above-described embodiments.

The display device DSP of the eleventh embodiment is different from that of the tenth embodiment in that the display device comprises a support member SA3 (third support member) instead of a support member SA2 and that a transparent substrate 20 includes an extending portion Ex22 on the counter-substrate CT. The extending portion Ex22 has been described above. The extending portion Ex22 of the transparent substrate 20 on the counter-substrate CT corresponds to a fourth extending portion.

A lens LN2 overlaps with the extending portion Ex22 in the third direction Z. From another viewpoint, the lens LN2 is provided between the extending portion Ex22 and the wiring board F2 in the third direction Z. The support member SA3 is provided between the extending portion Ex22 and the lens LN2. The support member SA3 has a main surface SA30 and a side surface SA31.

The main surface SA30 is opposed to the lens LN2. The side surface SA31 is opposed to a side surface E12 of a transparent substrate 10. The support member SA3 includes a reflective member RM3 provided on the main surface SA30. In the example shown in FIG. 18, the main surfaces SA30 and 10A are located in the same plane along the X-Y plane.

The lens LN2 is bonded to the wiring board F2 by an adhesive layer 104, and is bonded to the support member SA3 by an adhesive layer 105. The support member SA3 is bonded to a main surface 20A at the extending portion Ex22 by an adhesive layer 106.

The light source LS2, the lens LN2, and the transparent substrate 30 are arranged in this order along a direction opposite to the second direction Y. The light source LS2 and the lens LN2 are opposed to the side surface 30D. The lens LN2 is located under the support member SA3, and the light source LS2 and the lens LN2 are not opposed to the side surface E12 or E22. For this reason, the light emitted from the light sources LS2 is not made incident from the side surface E12.

The same advantages as those of each of the above-described embodiments can also be obtained from the configuration of the present embodiment.

### Twelfth Embodiment

A twelfth embodiment will be described. The same constituent elements as those of each of the above-described embodiments are denoted by the same reference symbols, and their description is omitted as appropriate.

FIG. 19 is a schematic cross-sectional view showing a display device DSP according to the twelfth embodiment. In the twelfth embodiment, the array substrate AR is an example of a second substrate, and the counter-substrate CT is an example of a first substrate. A configuration of the display panel PNL is the same as that of each of the above-described embodiments.

The display device DSP of the twelfth embodiment is different from that of the tenth embodiment in that a transparent substrate 10 includes an extending portion Ex12, on the array substrate AR, instead of a support member SA2. The extending portion Ex12 of the transparent substrate 10 on the array substrate AR corresponds to a fifth extending portion. The extending portion Ex12 has been described above.

A lens LN2 overlaps with the extending portion Ex12 in the third direction Z. From another viewpoint, the lens LN2 is provided between the extending portion Ex12 and the wiring board F2 in the third direction Z. The lens LN2 is bonded to a wiring board F2 by an adhesive layer 104, and bonded to a main surface 10A on the extending portion Ex12 by an adhesive layer 105.

The light source LS2, the lens LN2, and the transparent substrate 30 are arranged in this order along a direction opposite to the second direction Y. The light source LS2 and the lens LN2 are opposed to the side surface 30D. The lens LN2 is located under the extending portion Ex12, and the light source LS2 and the lens LN2 are not opposed to the side surface E12 or E22. For this reason, the light emitted from the light sources LS2 is not made incident from the side surface E12.

The same advantages as those of each of the above-described embodiments can also be obtained from the configuration of the present embodiment.

In the display device DSP of the fourth to twelfth embodiments, the light is emitted onto the side surfaces 30C and 30D of the transparent substrate 30, but the display device DSP may comprise the light source LS2, the lens LN2, and the like such that the light is emitted to the only side surface 30D.

### Thirteenth Embodiment

A thirteenth embodiment will be described. The same constituent elements as those of each of the above-described embodiments are denoted by the same reference symbols, and their description is omitted as appropriate.

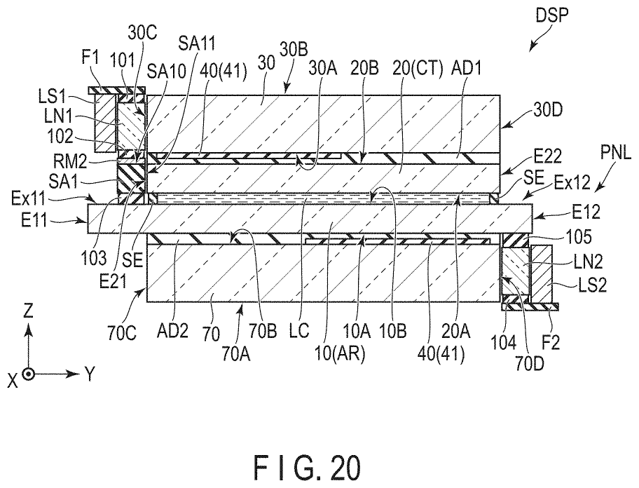

FIG. 20 is a schematic cross-sectional view showing a display device DSP according to the thirteenth embodiment. In the thirteenth embodiment, the array substrate AR is an example of a first substrate and the counter-substrate CT is an example of a second substrate. A side surface 30D of a transparent substrate 30 corresponds to a third side surface. A side surface E12 of a transparent substrate 10 on an array substrate AR corresponds to a fifth side surface.

A configuration of the display panel PNL is the same as that of each of the above-described embodiments. The display device DSP of the thirteenth embodiment comprises a transparent substrate 70 (second transparent substrate) instead of a cover member 50, and a light source LS2, a lens LN2, and the like are located under the display panel PNL.

In the display device DSP of the thirteenth embodiment, the transparent substrate 70, a low-refractive layer 40, the array substrate AR, the counter-substrate CT, a low-refractive layer 40, and a transparent substrate 30 are arranged in this order along the third direction Z.

The transparent substrate 70 has a flat shape parallel to the X-Y plane. The transparent substrate 70 has a main surface 70A, a main surface 70B on the side opposite to the main surface 70A, and a pair of side surfaces 70C and 70D that connect the main surfaces 70A and 70B to each other. The side surface 70D corresponds to a sixth side surface. The main surfaces 70A and 70B are surfaces substantially parallel to the X-Y plane. The main surface 70B is opposed to the main surface 10A of the transparent substrate 10.

The pair of side surfaces 70C and 70D are surfaces substantially parallel to the X-Z plane extending along the first direction X. In the example shown in FIG. 20, the side surface 70C is located just under a side surface 30C in the third direction Z, and the side surface 70D is located just under the side surface 30D in the third direction Z. The side surface 70D is located on a side opposite to the side surface 30C in the second direction Y.

As an example, the width in the third direction Z of the transparent substrate 70 is substantially equal to the thickness in the third direction Z of the transparent substrate 30. The transparent substrate 70 has a refractive index equal to the refractive index n1 of the transparent substrate 30. For example, the transparent substrate 70 is formed of the same member as the transparent substrate 30.

The low-refractive layer 40 is arranged on the main surface 70B of the transparent substrate 70, which is located on the liquid crystal layer LC side. The low-refractive layer 40 includes a plurality of strip portions 41 arranged at intervals in the first direction X. The adhesive layer AD2 is in contact with the main surface 10A, covers the low-refractive layer 40, and is in contact with the main surface 70B in an area where the low-refractive layer 40 is lost. On the low-refractive layer 40 arranged on the main surface 70B, strip portions 41 are formed such that a width in the first direction X of a gap GP between adjacent strip portions 41 increases along a direction opposite to the second direction Y.

The transparent substrate 10 includes an extending portion Ex12. A plurality of light sources LS2 and the lens LN2 are opposed to the side surface 70D in the second direction Y. The light sources LS2 emit light toward the side surface 70D of the transparent substrate 70 from a side opposite to the light sources LS1, in the second direction Y.

The lens LN2 is located between the side surface 70D and the light sources LS2 in the second direction Y. A lens LN2 overlaps with the extending portion Ex12 in the third direction Z. From another viewpoint, the lens LN2 is provided between the extending portion Ex12 and the wiring board F2 in the third direction Z. The lens LN2 is bonded to a wiring board F2 by an adhesive layer 104, and bonded to a main surface 10A on the extending portion Ex12 by an adhesive layer 105.

The light source LS2, the lens LN2, and the transparent substrate 30 are arranged in this order along a direction opposite to the second direction Y. The light sources LS2 and the lens LN2 are opposed to the side surface 70D. The lens LN2 is located under the extending portion Ex12, and the light source LS2 and the lens LN2 are not opposed to the side surface E12 or E22.

The light emitted from the light sources LS2 is diffused moderately by the lens LN2, and is made incident on the transparent substrate 70 from the side surface 70D. In contrast, the lens LN2 is not opposed to the side surface E12 or E22 as described above. For this reason, the light emitted from the light sources LS2 is not made incident from the side surface E12. The light made incident on the transparent substrate 70 from the side surface 70D reaches the liquid crystal layer LC through the transparent substrate 70. The light incident on the transparent substrate 70 travels inside the display panel PNL while being repeatedly reflected.

The same advantages as those of each of the above-described embodiments can also be obtained from the configuration of the present embodiment. A luminance difference on the display panel PNL can be further reduced by emitting light toward the side surface 30C of the transparent substrate 30 and the side surface 70D of the transparent substrate 70. For this reason, degradation in display quality can be suppressed by making the luminance on the display panel PNL uniform.

The configuration of the display device DSP of the thirteenth embodiment is merely an example. The light source LS1 may emit light toward the side surface 70C of the transparent substrate 70, and the light sources LS2 may emit light toward the side surface 30D of the transparent substrate 30. The above-described support members SA1 to SA3 and each of the extending portions Ex11, Ex12, Ex21, and Ex22 can be applied arbitrarily in accordance with the positions of the light sources LS1 and LS2 and the lenses LN1 and LN2. The transparent substrate 30 or 70 may further include an extending portion which extends along the second direction Y.

All of the display devices that can be implemented by a person of ordinary skill in the art through arbitrary design changes to the display devices described above as embodiments of the present invention come within the scope of the present invention as long as they are in keeping with the spirit of the present invention. Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device comprising:
a first substrate;
a second substrate opposed to the first substrate;
a polymer dispersed liquid crystal layer arranged between the first substrate and the second substrate;
a first transparent substrate having a first side surface and opposed to the second substrate; and
a first light source emitting light toward the first side surface,
the second substrate having a second side surface on the first side surface side,
the polymer dispersed liquid crystal layer being capable of switching a state in which light incident on the polymer dispersed liquid crystal layer is transmitted and a state in which the light is scattered, by applying a voltage,
the light emitted from the first light source being made incident on the first transparent substrate from the first side surface to reach the polymer dispersed liquid crystal layer via the first transparent substrate and being not made incident from the second side surface.

2. The display device of claim 1, further comprising:
a low-refractive layer having a lower refractive index than the first transparent substrate and arranged on a main surface of the first transparent substrate on the polymer dispersed liquid crystal layer side.

3. The display device of claim 1, further comprising:
a first lens located between the first side surface and the first light source.

4. The display device of claim 3, wherein
the first substrate includes a first extending portion which further extends than the first side surface, and
the first lens overlaps with the first extending portion in a thickness direction of the first substrate.

5. The display device of claim 4, further comprising:
a first support member, wherein
the first support member is located between the first lens and the first extending portion and is opposed to the second side surface.

6. The display device of claim 4, wherein
the second substrate further includes a second extending portion which further extends than the first side surface, and
the first lens overlaps with the second extending portion in the thickness direction.

7. The display device of claim 3, wherein
the second substrate includes a third extending portion which further extends than the first side surface, and
the first lens overlaps with the third extending portion in a thickness direction of the first substrate.

8. The display device of claim 5, further comprising:
a cover member opposed to the first substrate;
a second light source;
a second lens; and
a second support member, wherein
the first transparent substrate further has a third side surface on a side opposite to the first side surface,
the second substrate further has a fourth side surface on a side opposite to the first side surface,
the first substrate further has a fifth side surface on a side opposite to the first side surface,
the second light source emits light toward the third side surface,
the second lens is located between the third side surface and the second light source and overlaps with the cover member in the thickness direction,
the second support member is located between the second lens and the cover member and is opposed to the fourth side surface and the fifth side surface, and
the light emitted from the second light source is made incident on the first transparent substrate from the third side surface to reach the polymer dispersed liquid crystal layer via the first transparent substrate and is not made incident from the fourth or fifth side surface.

9. The display device of claim 5, further comprising:
a second light source;
a second lens; and
a third support member, wherein
the first substrate further includes a fourth extending portion which extends to a side opposite to the first side surface,
the first transparent substrate further has a third side surface on a side opposite to the first side surface,
the second substrate further has a fourth side surface on a side opposite to the first side surface,
the second light source emits light toward the third side surface,
the second lens is located between the third side surface and the second light source and overlaps with the fourth extending portion in the thickness direction,
the third support member is located between the second lens and the fourth extending portion and is opposed to the fourth side surface, and
the light emitted from the second light source is made incident on the first transparent substrate from the third side surface to reach the polymer dispersed liquid crystal layer via the first transparent substrate and is not made incident from the fourth side surface.

10. The display device of claim 5, further comprising:
a second light source; and
a second lens, wherein
the first transparent substrate further has a third side surface on a side opposite to the first side surface,
the second substrate includes a fourth side surface and further includes a fifth extending portion which extends to a side opposite to the first side surface,
the second light source emits light toward the third side surface,
the second lens is located between the third side surface and the second light source and overlaps with the fifth extending portion in the thickness direction, and
the light emitted from the second light source is made incident on the first transparent substrate from the third side surface to reach the polymer dispersed liquid crystal layer via the first transparent substrate and is not made incident from the fourth side surface.

11. The display device of claim 5, further comprising:
a second transparent substrate opposed to the first substrate;
a second light source; and
a second lens, wherein
the first transparent substrate further has a fifth side surface on a side opposite to the first side surface,
the second transparent substrate has a sixth side surface on a side opposite to the first side surface,
the second light source emits light toward the sixth side surface,
the second lens is located between the sixth side surface and the second light source, and
the light emitted from the second light source is made incident on the second transparent substrate from the sixth side surface to reach the polymer dispersed liquid crystal layer via the second transparent substrate and is not made incident from the fifth side surface.

12. A display device comprising:
a first substrate;
a second substrate opposed to the first substrate;
a polymer dispersed liquid crystal layer arranged between the first substrate and the second substrate;
a transparent substrate having a side surface and opposed to the second substrate;
a first light source emitting light toward the side surface;
a first lens located between the side surface and the first light source; and
a support member,
the first substrate including an extending portion which further extends than the side surface,
the first lens overlapping with the extending portion in a thickness direction of the first substrate,
the support member being located between the first lens and the extending portion.

13. The display device of claim 12, further comprising:
a low-refractive layer having a lower refractive index than the transparent substrate and arranged on a main surface of the polymer dispersed liquid crystal layer side of the transparent substrate.

14. The display device of claim 12, further comprising:
a second light source; and
a second lens, wherein
the second light source emits light toward the transparent substrate from a side opposite to the first light source, and
the second lens is located between the transparent substrate and the second light source.
